(19) United States
(12) Patent Application Publication
(10) Pub. No.: US 2010/0241516 A1
(43) Pub. Date: Sep. 23, 2010

(54) EDITING INTERFACE

(75) Inventors: Ye-Jeong Kim, Menlo Park, CA (US); Ambar Pansari, San Francisco, CA (US); Jeffrey Caesar, San Jose, CA (US); Joseph M. Ashear, Palo Alto, CA (US)

Correspondence Address: FISH & RICHARDSON P.C., PO BOX 1022, MINNEAPOLIS, MN, 55440-1022, US

(73) Assignee: Google Inc., Mountain View, CA (US)

(21) Appl. No.: 12/406,630

(22) Filed: Mar. 18, 2009

(51) Int. Cl. G06Q 30/00; G06F 17/00; G06F 17/24

(52) U.S. Cl. 705/14.73; 705/26; 715/218; 715/220; 715/255

(57) ABSTRACT

Systems and methods for editing online advertising campaigns from a summary interface. A summary interface can be provided. The summary interfaces shows filed fields associated with one or more advertising campaigns in a view mode. Upon receipt of a request to edit one or more of the fields, the summary interface transitions to an edit mode for editing of the selected fields and editing of hidden fields that are associated with the selected fields and that are not displayed in the view mode.

### BACKGROUND

This disclosure is related to interfaces for data tables.

The Internet enables access to a wide variety of content items, e.g., video and/or audio files, web pages for particular subjects, news articles, etc. Such access to these content items also enables opportunities for targeted advertising. For example, a query submitted to a search engine can be an indicator of the type of information of interest to the user that submitted the query, and the query is compared to advertiser-specified keywords to provide targeted advertisements. Likewise, online publishers can place an advertiser's text or image advertisements on web pages that have content related to the advertisement. As the users are likely interested in the particular content on the publisher webpage, they are also likely to be interested in the product or service featured in the advertisement.

Online advertisers use online advertising management tools to manage online advertising campaigns. These management tools include an editing interface that allows an advertiser to specify keywords for association with an advertisement or campaign and the price the advertiser is willing to pay for a placement. After the advertiser specifies the campaign data, the campaign and its associated performance statistics can be viewed in a separate summary interface. If the advertiser is dissatisfied with the summary statistics presented in the summary interface, the advertiser can revise the campaign data by use of the editing interface.

There are usually many cells defined by columns and rows in both interfaces, and often the editing interface includes additional cells that are not shown in the summary interface. The presence of multiple cells and in two or more functional interfaces increases the chances of erroneous edits.

### SUMMARY

Systems, methods and computer readable media for accounting for editing online advertising campaigns are provided. In an aspect, a method includes providing summary interface instructions to a client device, the summary interface instructions operable to cause the client device to display a summary interface of an advertising campaign, the summary interface comprising a plurality of fields associated with the advertising campaign; receiving a request to edit data associated with the advertising campaign from the client device, the request specifying a field displayed in the summary interface; identifying data related to a hidden field not displayed in the summary interface and related to the specified field and editable in the summary interface; and providing the data related to the hidden field to the client device; wherein the summary interface instructions are further operable to cause the client device to display the hidden field in response to the request to edit data associated with the advertising campaign. Other embodiments of this aspect include corresponding systems, apparatus, and computer program products.

In another aspect, a method includes providing summary interface instructions to a client device, the summary interface instructions operable to cause the client device to display a summary interface of an advertising campaign, the summary interface having a view mode and an edit mode, the summary interface displaying in the view mode a first plurality of fields associated with the advertising campaign, and displaying in the edit mode a second plurality of fields associated with the advertising campaign, the second plurality of fields including editable fields in the first plurality of fields and editable hidden fields corresponding to the editable fields in the first plurality of fields, and wherein the summary interface instructions are operable to cause the client device to only display the editable hidden fields in the edit mode; receiving a request to edit data associated with the advertising campaign from the client device, the request specifying a field displayed in the summary interface in the view mode; identifying data related to a hidden field and related to the specified field; and providing the data related to the hidden field to the client device; wherein the summary interface instructions are further operable to cause the summary interface to enter the edit mode in response to the request to edit data associated with the advertising campaign. Other embodiments of this aspect include corresponding systems, apparatus, and computer program products.

Particular embodiments of the subject matter described in this specification can be implemented to realize one or more of the following advantages. Cells in a table can be presented in either an edit mode or a view mode. When presented in the edit mode, additional cells that are related to the cell and that are not shown in the view mode can be displayed. These additional cells can store date for hidden attributes that are not shown in the view mode, and their display thus simplifies the editing of all attributes for a displayed cell. By selecting a specific cell to edit, only the additional cells related to the hidden attributes of the selected cell to be edited can be shown, thus conserving screen real estate. A bulk-change can be applied to a column corresponding to a cell so that data in all cells in that column can be changed in accordance with the bulk-change. Transitioning between view and edit modes in the user interface is not require, and thus interface refreshing, which results a noticeable time lag to the user, can be minimized.

The advantages and features listed in the above list are optional and not exhaustive. The advantages and features can be separately realized or realized in various combinations.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF DRAWINGS

FIG. 1 is a block diagram of an example online environment.

FIG. 2 is a screen shot representation of an example advertising campaign summary interface.

FIGS. 3A-H are screen shot representations of an example summary interface with integrated editing capability.

FIG. 4 is a flowchart of an example method for editing an online advertising campaign from a summary interface.

FIG. 5 is block diagram of an example computer system.

### DETAILED DESCRIPTION

Editing of an online advertising campaign can be facilitated through a summary interface. The summary interface can include a row for each keyword included in an online advertising campaign. When an advertiser associated with the online advertising campaign requests to edit at least a portion of the online advertising campaign, the summary interface can enable editable fields in the summary interface to be edited from within the summary interface, rather than requiring the advertiser visit a separate campaign editing interface.

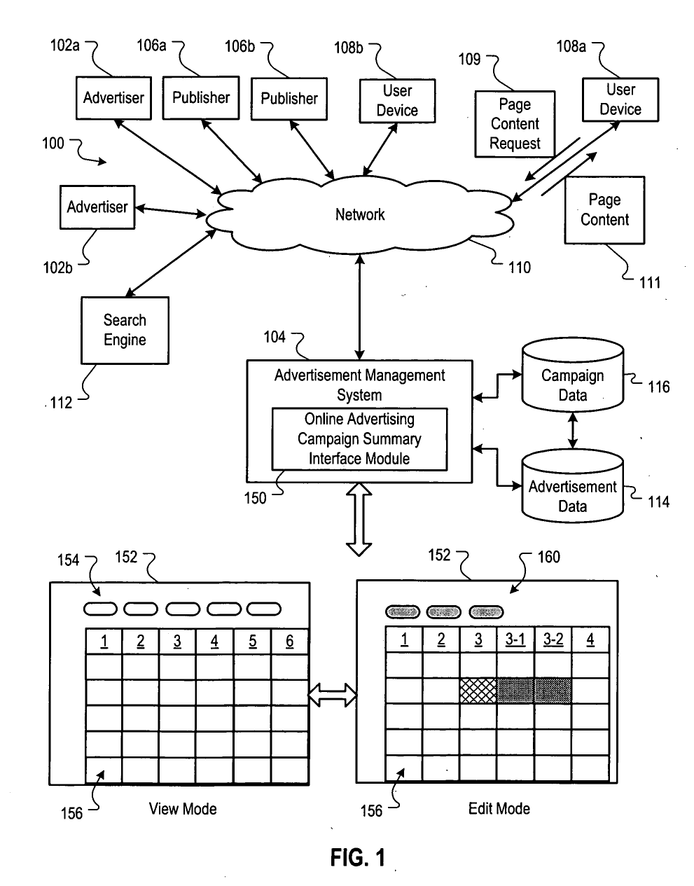

The subject matter of this specification can be implemented in an online environment, such as the example online environment 100 shown in FIG. 1. The online environment 100 can facilitate the identification and serving of content items, e.g., web pages, advertisements, etc., to users. A computer network 110, such as a local area network (LAN), wide area network (WAN), the Internet, or a combination thereof, connects advertisers 102a and 102b, an advertisement management system 104, publishers 106a and 106b, user devices 108a and 108b, and a search engine 112. Although only two advertisers (102a and 102b), two publishers (102a and 102b) and two user devices (108a and 108b) are shown, the online environment 100 may include many thousands of advertisers, publishers and user devices.

In the online environment 100, one or more advertisers 102a and/or 102b can directly, or indirectly, enter, maintain, and track online advertisement information in the advertising management system 104. The online advertisements can be in the form of graphical advertisements, such as banner advertisements, text only advertisements, image advertisements, audio advertisements, video advertisements, advertisements combining one of more of any of such components, etc., or any other type of electronic advertisement.

A user device, such as user device 108a, can submit a page content request 109 to a publisher 106 or the search engine 112 and receive page content 111 in return. The page content 111 can include advertisements provided by the advertisement management system 104, or can include executable instructions, e.g., JavaScript™, that can be executed at the user device 108a to request advertisements from the advertisement management system 104. Example user devices 108 include personal computers, mobile communication devices, television set-top boxes, etc.

Advertisements can also be provided from the publishers 106. For example, one or more publishers 106a and/or 106b can submit advertisement requests for one or more advertisements to the system 104. The system 104 responds by sending the advertisements to the requesting publisher 106a or 106b for placement on one or more of the publisher's web properties (e.g., websites and other network-distributed content). The advertisements can include embedding links landing pages, e.g., pages on the advertisers 102 websites that a user is directed to when the user clicks on an ad presented on a publisher website.

In some implementations, a publisher 106 can combine the requested content with one or more of the advertisements provided by the system 104. This combination of page content and advertisements can be sent to the user device 108 that requested the content (e.g., user device 108a) as page content 111 for presentation in a viewer (e.g., a browser or other content display system). The publisher 106 can transmit information about the advertisements back to the advertisement management system 104.

Publishers 106a and 106b can include general content servers that receive requests for content (e.g., articles, discussion threads, music, video, graphics, search results, web page listings, information feeds, etc.), and retrieves the requested content in response to the request. For example, content servers related news content providers, retailers, independent blogs, social network sites, or any other entity that provides content over the network 110 can be a publisher.

Advertisements can also be provided through the use of the search engine 112. The search engine 112 can receive queries for search results. In response, the search engine 112 can retrieve relevant search results from an index of documents (e.g., from an index of web pages). Search results can include, for example, lists of web page titles, snippets of text extracted from those web pages, and hypertext links to those web pages, and may be grouped into a predetermined number of (e.g., ten) search results.

The search engine 112 can also submit a request for advertisements to the system 104. The request for advertisements can include the query (as entered or parsed), information based on the query (such as geo-location information, whether the query came from an affiliate and an identifier of such an affiliate), and/or information associated with, or based on, the search results, and the system 104 can provide relevant advertisements in response. The search engine 112 can combine the search results with one or more of the advertisements provided by the system 104. This combined information can then be forwarded to the user device 108 that requested the content as the page content 111.

The advertisers 102, user devices 108, and/or the search engine 112 can also provide usage information to the advertisement management system 104. This usage information can include measured or observed user behavior related to advertisements that have been served, such as, for example, whether or not a conversion or a selection related to an advertisement has occurred. The user behavior of selecting an advertisement can be referred to as an online response to the advertisement, e.g., a click-through. In some implementations, the system 104 can perform financial transactions, such as crediting the publishers 106 and charging the advertisers 102 based on the usage information. Such usage information can also be processed to measure performance metrics, such as a click-through rate (“CTR”), conversion rate, and other measurable performance metrics for online responses.

A click-through occurs when a user of a user device, selects or “clicks” on a link to a content item returned by the publisher or the advertising management system. The CTR is a performance metric that is obtained by dividing the number of users that clicked on the content item, e.g., a link to a landing page, an advertisement, or a search result, by the number of times the content item was delivered. A “conversion” occurs when a user consummates a transaction related to a previously served advertisement.

In addition to the advertisements being selected based on content such as a search query or web page content of a publisher, the advertisements are also selected based on an auction process in the advertisement management system 104. The advertisers 102 are permitted to select, or bid, an amount they are willing to pay for each click of an advertisement, e.g., a cost-per-click amount an advertiser pays when, for example, a user clicks on an advertisement. The cost-per-click can include a maximum cost-per-click, e.g., the maximum amount the advertiser is willing to pay for each click of an advertisement based on a keyword.

An advertisement can also be associated with an actual cost-per-click. The actual cost-per-click of the advertisement can be determined by the maximum cost-per-click of the advertisement, a quality score of the advertisement, and by the amount selected or bid by the advertiser directly below. The actual cost-per-click is the price that is necessary to keep the advertisement's position above the next advertisement. To determine the actual cost-per-click, the system 104 can determine how much the advertiser in position 1 would have to pay to give it a rank equal to the advertiser in position 2, and then the system 104 adds a unit amount, e.g., $0.01, to this determined amount.

The advertisements, associated usage data, and bidding parameters described above can be stored as advertisement data in an advertisement data store 114. An advertiser 102 can further manage the serving of advertisements by specifying an advertising campaign. The data defining an advertising campaign can be stored in campaign data in a campaign data store 116, which can, for example, specify advertising budgets for advertisements; when, where and under what conditions particular advertisements may be served for presentation; etc.

In some implementations, the advertising management system 104 can include an online advertising campaign summary interface module 150. The online advertising campaign summary interface module 150 can provide a summary interface 152 to a user device associated with an advertiser. An example summary interface 152 is an HTML document that is rendered in a web browser. Other instructions that can cause a processing device to display the summary interface 152 can also be used. The summary interface 152 has a view mode and an edit mode. In the view mode, the summary interface 152 provides an advertising campaign summary to an advertiser. The summary can enable the advertiser to quickly review the status of an advertising campaign by seeing keywords used in the campaign, whether such keywords are active, bidding for various keywords, performance of the keywords, etc. As shown, the view mode of the summary interface 152 includes one or more summary commands 154 (e.g., sorting commands, filtering commands, etc.) that operate on a cells 156 arranged according to columns and rows.

In the edit mode, the summary interface 152 facilitates editing of the cell fields displayed within the campaign summary interface. For example, an advertiser may be viewing the summary interface 152 and would like to change a keyword, status or bid associated with the campaign. The editing is facilitated from within the summary interface, thereby increasing the connection between the summary interface and the edits desired by the advertiser. For example, if the advertiser were required to visit a separate editing interface to make changes to the advertising campaign, the advertiser might lose track of the changes he or she wanted to make to the campaign.

The online advertising campaign summary interface 152 further facilitates editing of hidden fields. Hidden fields are editable fields that are not included in the summary interface in the view mode and are related to one or more cells, or data stored in those cells, that are selected in the view mode for editing. For example, as shown in FIG. 1, the cross hatched cell in column 3 has been selected for editing, and the hidden fields 3-1 and 3-2, which are related to selected cell but are not displayed in the view mode, are displayed in the edit mode.

In response to entering the edit mode, the summary interface 152 causes a client device to request data for the hidden fields that are displayed. The request is sent to the advertisement management system 104, which in turn provides the requested data to the client device. In some implementations, the request can specify the hidden fields. In other implementations, the request can identify the cell selected for editing, and corresponding data for hidden fields are identified and sent to the client device, where the hidden fields are then displayed for editing.

Fields may be hidden in response to an advertiser specification, or in response to a default field status. A hidden field can be used to show data during an edit mode that an advertiser may not be primarily concerned with in view mode. Example hidden fields include a field for a landing page associated with an advertisement or campaign. For example, a landing page URL associated with the campaign might not normally be displayed within the summary interface 152. However, when the advertiser selects to edit the information associated with one or more keywords or fields of the summary interface, the online advertising campaign summary interface module 152 can insert the hidden field that includes the landing page URL into the summary interface and enable the fields for editing. As used herein, the term “insert” means to cause the hidden field to be displayed in the summary interface 152 in an edit mode.

Thus, in the view mode, the summary interface 152 displays a first plurality of fields associated with the advertising campaign, and in the edit mode, the summary interface displays a second plurality of fields associated with the advertising campaign. The second plurality of fields including editable fields in the first plurality of fields and editable hidden fields corresponding to the editable fields in the first plurality of fields.

In some implementations, the hidden fields are specified in the instructions that are used to render the summary interface 152 at a client device, and the instructions are configured to only display the hidden fields when a corresponding field displayed in the view mode is selected. In other implementations, the hidden fields are not specified in the instructions that are used to render the summary interface 152 at a client device, and additional instructions are provided to cause the client device display the hidden fields win response to a selection of a corresponding field displayed in the view mode.

In some implementations, insertion of a column may push other columns out of view. For example, if a landing page universal resource locator (URL) is inserted into a row associated with a selected keyword being edited, some performance rows can be shifted right or removed from the summary interface temporarily in order to facilitate display of the hidden field for editing. In some implementations, the fields that are removed are uneditable filed, i.e., fields that cannot be edited. In other implementations, only the selected rows may show the hidden fields, and those rows that do not included selected cells can be rendered according to the view mode.

In some implementations, the edit mode of the summary interface 152 includes one or more edit commands 160. The edit commands 160 operate on selected cells in the edit mode. In some implementations, the edit commands are only shown in the edit mode, and the summary commands are only shown in the view mode.

In some implementations, the online advertising campaign summary interface 152 can provide an indication of which of the fields associated with a keyword are editable. For example, if a selection tool (e.g., a mouse pointer representation) is hovered over a row associated with a keyword, the editable fields can be outlined to provide an indication to the advertiser regarding which of the fields are editable. In other examples, if a checkbox representation is selected or a row associated with a keyword is otherwise highlighted, the summary interface can provide an indication of which of the fields in the checked or highlighted row are editable.

In some implementations, the online advertising campaign summary interface 152 can provide notification when data entered into a row is erroneous (e.g., against policy, of a wrong data-type, etc.). For example, if an advertiser attempts to enter the name of a prescription drug and the advertiser account is not associated with a prescription provider, the online advertising campaign summary interface 152 can notify the advertiser that it is against policy for the advertiser to use such keywords. In another example, if a field type is associated with numerical data and the data entered includes an alphabetic character, the online advertising campaign summary interface 152 can notify the advertiser that the data entered is non-numerical.

In some implementations, the edit commands 160 can further operation on all cells in a column in which a cell is selected in a bulk-edit mode. In some implementations, the online advertising campaign summary interface 152 can further provide a bulk-edit option to the advertiser, whereby data entered in a selected field is used to fill in a plurality of other similar fields being edited. For example, an advertiser might want to provide the same bid for a plurality of keywords. Thus, the advertiser can selected the keywords and request to edit the fields associated with the keywords. The advertiser can enter a bid associated with the keyword, and instruct the online advertising campaign summary interface 152 to use the entered bid to fill the remaining bid fields selected for editing.

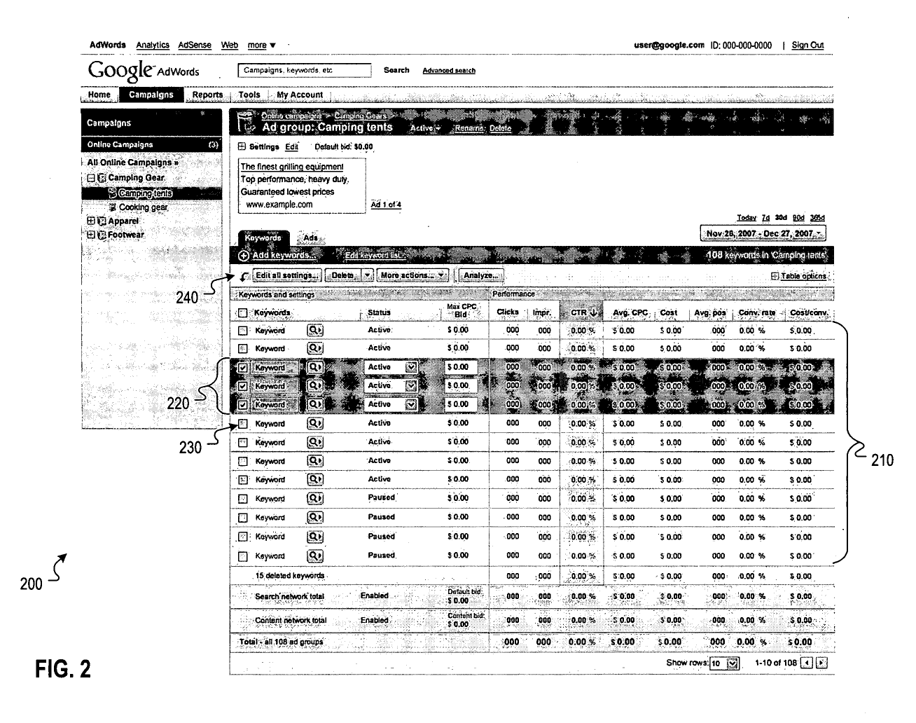

FIG. 2 is a screen shot representation of an example advertising campaign summary interface 200. The advertising campaign summary interface 200 includes a plurality of rows 210 shown in a view mode. Each of the plurality of rows 210 can be associated with a keyword. In some implementations, the keywords can be selected by the advertiser and added to the campaign from a campaign creation/editing interface. In other implementations, the keywords can be added to the campaign from the summary interface using an “Add Keywords” link representation within the summary interface.

In some implementations, selected rows 220 from the plurality of rows 210 can be highlighted using a checkbox representation 230. The checkbox representation 230 can be selected using a selection tool (e.g., including a mouse pointer representation controlled by a mouse device). For example, a plurality of rows can be selected either by individually selecting each check box, or by selecting the rows and then selecting any one of the checkboxes. Upon selection, the editable fields associated with the selected rows 220 can be outlined to provide the advertiser with notification of which fields in the selected rows 220 can be edited by the advertiser.

The advertising campaign summary interface 200 can further include a plurality of button representations 240 operable to request editing of a selected row of keywords. For example, if the advertiser would like to edit a “Status” field of a keyword, he or she could select the keyword and select the “Edit Settings” button representation to edit the “Status” field of the selected keyword.

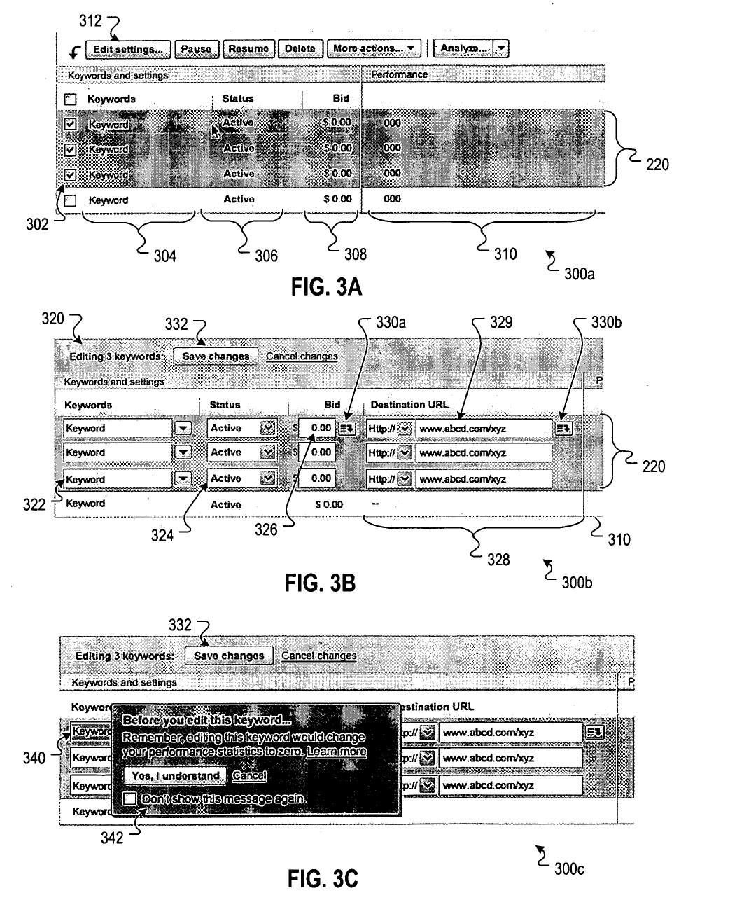

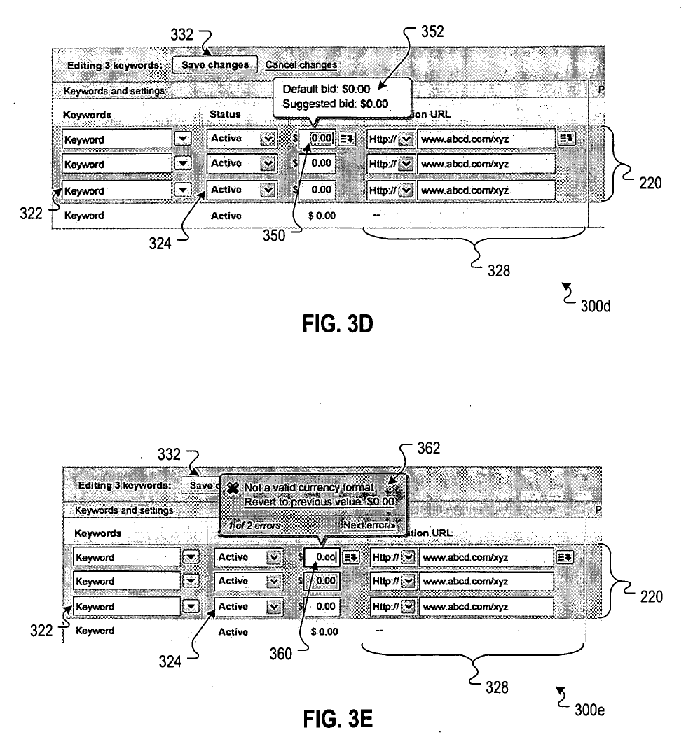

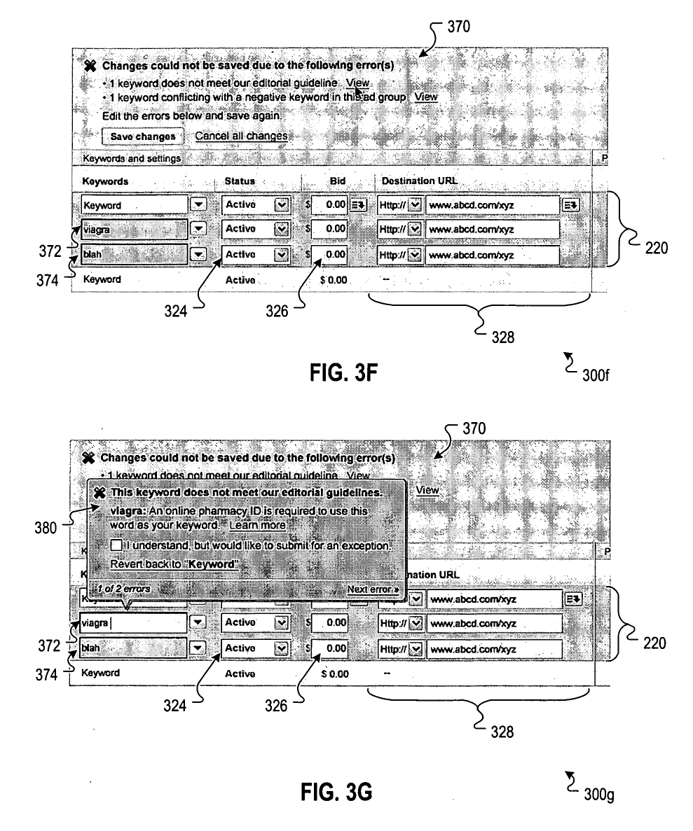

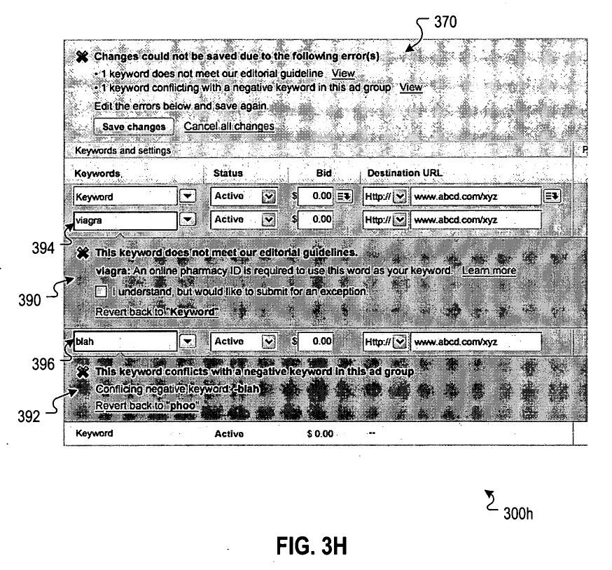

FIGS. 3A-H are screen shot representations of an example summary interface with integrated editing capability. FIG. 3A is a screen shot representation of a summary interface 300a before edit mode is entered, i.e., in view mode. The summary interface 300a can include a plurality of selected rows 220 representing keywords selected by the advertiser using the checkbox representation 302 associated with the keyword. Each of the plurality of selected rows 220 can include a plurality of fields, including, for example, a keyword 304, a status identifier 306, a bid identifier 308, and performance information 310. The summary interface 300 can also include a plurality of button representations 312. The button representations can include, for example, an “Edit Setting” button representation, a “Pause” button representation, a “Resume” button representation, a “Delete” button representation, a “More Actions” drop down button representation, and an “Analyze” drop down button representation.

Upon selection of the “Edit Setting” button representation of FIG. 3A, the summary interface 300a can transition to summary interface 300b of FIG. 3B. The summary interface 300b is in the edit mode, and an edit mode indication 320 can replace the button representations 312 of FIG. 3A.

The summary interface 300b can facilitate editing of the editable fields. The editable fields can include, for example, the “Keywords” field representation 322, a “Status” drop down selection representation 324, and a “Bid” field representation 326. In some implementation, the summary interface 300b can include hidden fields (e.g., hidden field 329) not normally displayed in the summary interface. In the example of FIG. 3B, the hidden field 329 includes a “Destination URL” field representation 328 identifying a landing page associated with the advertisement or campaign.

In some implementations, some fields can include one or more bulk-edit button representations 330a, 330b. Selection of the bulk-edit button representation 330a can cause the value entered in the “Bid” field 326 to be replicated in all “Bid” fields being edited. Selection of the bulk-edit button representation 330b can cause the data entered in a first “Destination URL” field representation 328 being edited to be replicated in all “Destination URL” fields 328 being edited.

In some implementations, a “Save Changes” button representation can be selected to exit the edit mode of the summary interface 300b and return to the summary interface 300a of FIG. 3A.

If an advertiser selects to edit a keyword in the edit mode of summary interface 300b, the selected keyword 340 can be highlighted for editing, as shown in summary interface 300c of FIG. 3C. In some implementations, when the advertiser selected to edit a keyword 340, a warning notification can be provided to the advertiser, with a confirmation that the advertiser understands the results of editing the keyword.

If an advertiser selects to edit a “Bid” field representation 326 of summary interface 300b, the selected “Bid” field representation 350 can be highlighted for editing, as shown in summary interface 300d of FIG. 3D. In some implementations, the summary interface 300d can retrieve a suggested bid from an advertising management system (e.g., advertising management system 104 of FIG. 1) through an online advertising campaign summary interface module (e.g., online advertising campaign summary interface module 150 of FIG. 1). The suggested bid and/or a default bid (e.g., set by the system administrator or by the advertiser) can be displayed to the advertiser as shown in popup representation 352. The suggested bid can be based upon, for example, an estimation of the audience the user desires to reach, a budget associated with the campaign, and an optimization of user actions (e.g., conversions, click-through, etc.), among many others.

In some implementations, if an advertiser enters an invalid number into the “Bid” field representation 350, a notification 362 can be provided alerting the advertiser to the error, as shown in summary interface 300e of FIG. 3E. In this example, the advertiser has entered alphabetical characters (“o”) into the “Bid” field representation 360. Such characters are invalid because they are not a valid currency format.

FIG. 3F is a screen shot representation of an example summary interface 300f displaying notification 370 of an error in the data entered for keywords 372, 374. In this example, the advertiser has entered “viagra” in keyword field representation 372 and “blah” in keyword field representation 374. The summary interface indicates these keywords are in error by highlighting the erroneous keywords, e.g., by shading the keywords in red. The error notification 370 indicates that one keyword does not meet the editorial guidelines of the advertising system, and one keyword conflicts with a negative keyword in the advertisement group.

In some implementations, when the advertiser selects one of the marked keywords for editing, summary interface 300g (as shown in FIG. 3G) can provide a popup error notification 380 identifying the particular error noted with respect to the selected keyword. In the example of FIG. 3G, the popup error notification indicates that the keyword selected does not meet the editorial guidelines of the advertising system. In this particular example, the error indicates that an online pharmacy identification is required to use the specified keyword. It should be noted that this is merely an example of a policy that might be implemented by an advertising system, but that this policy is not a necessary or required component of any particular implementation of the present disclosure.

FIG. 3H is an alternative implementation of the error notification shown in the summary interface 300g of FIG. 3G. The summary interface 300h of FIG. 3H depicts inline error indications 390, 392 identifying the errors in the keywords. For example, the keyword “viagra” 394 is outlined in red, and is followed by an indication 390 of the error detected with respect to the keyword “viagra.” The keyword “blah” 396 is similarly outlined in red, and is followed by an indication 392 of the error detected with respect to the keyword “blah.”

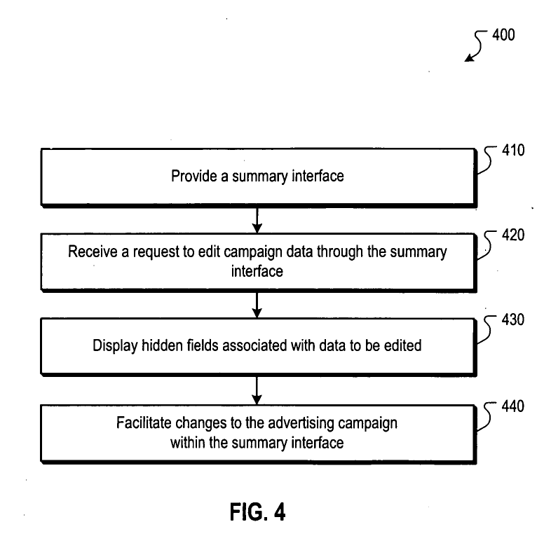

FIG. 4 is a flowchart of an example method for editing an online advertising campaign from a summary interface. At stage 410, a summary interface for an ad campaign is provided. The summary interface can be provided, for example, by an online advertising campaign summary interface module (e.g., online advertising campaign summary interface module 150 of FIG. 1). The summary interface can provide campaign information and associated campaign performance statistics. The summary interface can facilitate review of the campaign by an advertiser.

At stage 420, a request to edit campaign data through the summary interface is received. The request to edit the summary interface can be received, for example, by an online advertising campaign summary interface module (e.g., online advertising campaign summary interface module 150 of FIG. 1). For example, when an advertiser wants to edit a campaign, the advertiser can select a keyword and then select a button representation to edit the fields associated with a keyword.

At stage 430, hidden fields associated with the data to be edited are displayed. The hidden fields can, for example, include attributes associated with the data to be edited and that are not normally displayed in a view mode.

At stage 440, changes to the advertising campaign are facilitated from within the summary interface. Changes to the advertising campaign can be facilitated from within the summary interface, for example, by an online advertising campaign summary interface module (e.g., online advertising campaign summary interface module 150 of FIG. 1). Thus, changes can be made to the advertising campaign from within the summary interface without returning to a campaign management interface or other editing interface. In some implementations, the summary interface can check the changes made to the fields being edited to ensure that invalid data is not saved to the campaign.

In some implementations, hidden fields, which are editable, by the advertiser can be identified and inserted into the summary interface for editing by the advertiser. For example, if a landing page associated with an advertisement or campaign is not displayed in the summary interface, the landing page can field can be inserted into the summary interface when an editing mode is entered within the summary interface. In some implementations, where hidden fields are inserted within the summary interface, non-editable fields can be removed from the summary interface or otherwise shifted to make room for the hidden fields.

In some implementations, a bulk-editing option can be provided for selected fields being edited. For example, the advertiser can enter data into a single field and request that the data be used to populate similar fields being edited.

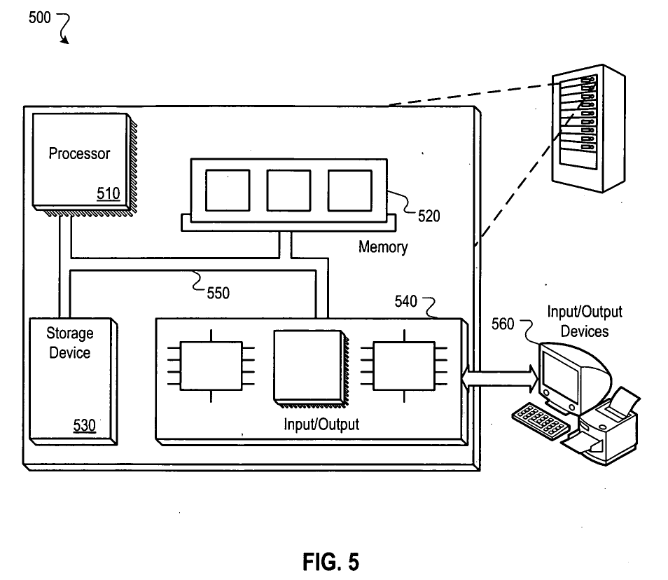

FIG. 5 is block diagram of an example computer system 500. The system 500 includes a processor 510, a memory 520, a storage device 530, and an input/output device 540 that collectively define a data processing apparatus. Each of the components 510, 520, 530, and 540 can, for example, be interconnected using a system bus 1350. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 can, for example, include a hard disk device, an optical disk device, or some other large capacity storage device.

The input/output device 540 provides input/output operations for the system 500. In one implementation, the input/output device 540 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other input/output devices, e.g., keyboard, printer and display devices 560. Other implementations, however, can also be used, such as mobile computing devices, mobile communication devices, set-top box television client devices, etc.

The advertising management system 104 and/or online advertisement campaign summary interface module 150, and components thereof, can be realized by instructions that upon execution cause one or more processing devices to carry out the processes and functions described above. Such instructions can, for example, comprise interpreted instructions, such as script instructions, executable code, or other instructions stored in a computer readable medium. The advertising management system 104 and/or online advertisement campaign summary interface module 150, and components thereof, can be distributively implemented over a network, such as a server farm, or can be implemented in a single computer device.

Although the editing interface has been described in the context of an advertisement management interface in this disclosure, the editing functions can be applied to other interfaces that can be used to display editable data related to any object, whether those objects are physical or can only be apprehended intellectually. Example objects in addition to advertising campaigns include, parts for a manufacture, student body demographics for a college campus, and real estate listings, sales, commissions, and realtor performance, to name just a few.

Furthermore, the interface can be used in conjunction with other advertising management interfaces, such as advertising management interfaces that provide bulk upload capabilities of advertisement data.

The interface and the identification of hidden fields and display of such fields can also be used in stand alone client applications, such as spreadsheets and databases. For example, spreadsheet applications, word processing applications, and database applications can include the capabilities of providing view modes and edit modes as described above. Likewise, the bulk fill functionality can be incorporated into stand alone client applications.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus.

A computer program (also known as a program, software, software application, script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Additionally, the logic flows and structure block diagrams described in this patent document, which describe particular methods and/or corresponding acts in support of steps and corresponding functions in support of disclosed structural means, may also be utilized to implement corresponding software structures and algorithms, and equivalents thereof. The processes and logic flows described in this specification can be performed by one or more programmable processors executing one or more computer programs to perform functions by operating on input data and generating output.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

To provide for interaction with an advertiser/user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

This written description sets forth the best mode of the invention and provides examples to describe the invention and to enable a person of ordinary skill in the art to make and use the invention. This written description does not limit the invention to the precise terms set forth. Thus, while the invention has been described in detail with reference to the examples set forth above, those of ordinary skill in the art may effect alterations, modifications and variations to the examples without departing from the scope of the invention.

What is claimed is:

1. A computer-implemented method, comprising:
providing summary interface instructions to a client device, the summary interface instructions operable to cause the client device to display a summary interface of an advertising campaign, the summary interface comprising a plurality of fields associated with the advertising campaign;
receiving a request to edit data associated with the advertising campaign from the client device, the request specifying a field displayed in the summary interface;
identifying data related to a hidden field not displayed in the summary interface and related to the specified field and editable in the summary interface; and
providing the data related to the hidden field to the client device;
wherein the summary interface instructions are further operable to cause the client device to display the hidden field in response to the request to edit data associated with the advertising campaign.

2. The computer-implemented method of claim 1, wherein the hidden field corresponds to one or more landing pages for the advertising campaign.

3. The computer-implemented method of claim 1, further comprising:
removing uneditable fields from the summary interface to provide space for the hidden field to be inserted.

4. The computer-implemented method of claim 1, wherein:
the request to edit the advertising campaign comprises an indication of one or more keywords to be edited; and further comprising:
providing a bulk-edit option for a bid associated with the one or more keywords to be edited, the bulk-edit option being operable to change the bids associated with the one or more keywords to match a bid associated with a selected bid.

5. The computer-implemented method of claim 1, wherein the summary interface comprises a plurality cells defined by rows and columns, each cell corresponding to a field, and the summary interface instructions are operable to cause the client device to provide an indication of which fields in a row are editable in response to hovering a selection tool over the row.

6. A computer-implemented method comprising:
providing summary interface instructions to a client device, the summary interface instructions operable to cause the client device to display a summary interface of an advertising campaign, the summary interface having a view mode and an edit mode, the summary interface displaying in the view mode a first plurality of fields associated with the advertising campaign, and displaying in the edit mode a second plurality of fields associated with the advertising campaign, the second plurality of fields including editable fields in the first plurality of fields and editable hidden fields corresponding to the editable fields in the first plurality of fields, and wherein the summary interface instructions are operable to cause the client device to only display the editable hidden fields in the edit mode;
receiving a request to edit data associated with the advertising campaign from the client device, the request specifying a field displayed in the summary interface in the view mode;
identifying data related to a hidden field and related to the specified field; and
providing the data related to the hidden field to the client device;
wherein the summary interface instructions are further operable to cause the summary interface to enter the edit mode in response to the request to edit data associated with the advertising campaign.

7. The computer-implemented method of claim 6, wherein the request to edit data associated with the advertising campaign comprises receiving data indicating one or more keywords to be edited; and
wherein the summary interface instructions are further operable to cause the client device to provide a bulk-edit option for a bid associated with the one or more keywords to be edited, the bulk-edit option being operable to change the bids associated with the one or more keywords to match a bid associated with a selected bid.

8. The computer-implemented method of claim 6, wherein the summary interface comprises a plurality cells defined by rows and columns, each cell corresponding to a field, and the summary interface instructions are operable to cause the client device to provide an indication of which fields in a row are editable in response to hovering a selection tool over the row.

9. The computer-implemented method of claim 6, wherein the summary interface comprises a plurality cells defined by rows and columns, each cell corresponding to a field, and the summary interface instructions are operable to cause the client device to display on the hidden fields associated with a selected field.

10. Computer-readable media having instructions stored thereon, which, when executed by a data processing apparatus, causes the data processing apparatus to perform operations comprising:
display a summary interface in a view mode, the summary interface operable to provide a summary of an advertising campaign, the summary interface comprising a plurality of fields associated with the advertising campaign;
receive a input request to edit data associated with the advertising campaign;
identify a hidden field not displayed in the summary interface and that is editable at the client device; and
insert the hidden field into the summary interface in an edit mode in which the hidden fields are displayed.

11. The computer readable media of claim 10, wherein the hidden field corresponds to one or more landing pages for the advertising campaign.

12. The computer-readable media of claim 10, wherein the instructions are further operable to cause the data processing apparatus to perform operations comprising:
removing uneditable fields from the summary interface to provide space for the hidden field to be inserted.

13. The computer readable media of claim 10, wherein the request to edit the advertising campaign comprises data indicating one or more keywords to be edited.

14. The computer-readable media of claim 13, wherein the instructions are further operable to cause the data processing apparatus to provide a bulk-edit option for a bid associated with the one or more keywords to be edited, the bulk-edit option upon selection by the advertiser being operable to change the bids associated with the one or more keywords to match a bid associated with a selected bid.

15. The computer readable media of claim 10, wherein changes are enabled only for editable fields, the editable fields being a subset of the plurality of fields displayed in the summary interface.

16. The computer readable media of claim 10, wherein the summary interface comprises a plurality cells defined by rows and columns, and the instructions are operable to cause the data processing apparatus to display an indication of which fields in a row are editable in response to hovering a selection tool over the row.

17. A system, comprising:
a data store storing data representative of an object; and
instructions stored on a computer readable medium and executable by a data processing apparatus to cause the data processing apparatus to perform operations comprising:
display a summary interface of the object, the summary interface having a view mode and an edit mode, the summary interface displaying in the view mode a first plurality of fields associated with the object, and display in the edit mode a second plurality of fields associated with the object, the second plurality of fields including editable fields in the first plurality of fields and editable hidden fields corresponding to the editable fields in the first plurality of fields, and wherein the summary interface displays only display the editable hidden fields in the edit mode;
receive a selection specifying a field displayed in the summary interface in the view mode;
identify data related to a hidden field corresponding to the specified field; and
change the summary interface to the edit mode in response to the selection to edit data associated with the object, the edit mode displaying the identified data related to the hidden field corresponding to the specified field.

18. The system of claim 17, wherein the object is an advertising campaign.
